(19) United States
(12) Patent Application Publication
(10) Pub. No.: US 2025/0063145 A1
(43) Pub. Date: Feb. 20, 2025

(54) AUGMENTED REALITY OVERLAY AND MAP ON MOBILE VIDEO MANAGEMENT SYSTEM

(71) Applicant: Tyco Fire & Security GmbH, Neuhausen am Rheinfall (CH)

(72) Inventors: Adam SANDLER, Milwaukee, WI (US); Benjamin SAMPLE, Milwaukee, WI (US); James Lee BAUERLE, JR., Milwaukee, WI (US)

(21) Appl. No.: 18/805,381

(22) Filed: Aug. 14, 2024

Related U.S. Application Data
(60) Provisional application No. 63/532,851, filed on Aug. 15, 2023.

(51) Int. Cl. H04N 7/18; G06T 11/00

(52) U.S. Cl. CPC H04N 7/181; G06T 11/00

(57) ABSTRACT

Example implementations include a method, apparatus, and computer-readable medium for providing guidance regarding an incident at a premises to a responder. The premises is equipped with a video management system (VMS) including a network video recorder (NVR). The VMS sends a mobile device, a notification including a location of the incident at the premises. The mobile device displays a map from a current location of the mobile device to the premises. The mobile device transmits, the current location of the mobile device to the VMS. The mobile device receives, from the VMS, one or more virtual resources at the premises near the location of the mobile device. The mobile device adds a camera feed of the mobile device as a new camera within the NVR. The mobile device augments the camera feed on the mobile device with an image associated with the one or more virtual resources.

The present application claims priority to, and the benefit of, U.S. Provisional Application No. 63/532,851 filed Aug. 15, 2023 and entitled “AUGMENTED REALITY OVERLAY AND MAP ON MOBILE VIDEO MANAGEMENT SYSTEM,” the contents of which are hereby incorporated by reference in their entireties.

### FIELD

### Field

The present disclosure relates generally to an augmented reality overlay and map on a mobile video management system.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the techniques described herein relate to a method of providing guidance regarding an incident at a premises to a responder, the method executed on a mobile device and including: receiving, at the mobile device, a notification including a location of the incident at the premises, wherein the premises is equipped with a video management system (VMS) including a network video recorder (NVR); displaying a map from a current location of the mobile device to the premises; transmitting, the current location of the mobile device to the VMS; receiving, from the VMS, one or more virtual resources at the premises near the location of the mobile device; adding a camera feed of the mobile device as a new camera within the NVR; and augmenting the camera feed on the mobile device with an image associated with the one or more virtual resources.

In some aspects, the techniques described herein relate to a method, further including: displaying, on the mobile device, an access control for a hardware component of the NVR associated with a virtual resource; and transmitting a command to control the hardware component via the NVR in response to a user interaction with the access control.

In some aspects, the techniques described herein relate to a method, wherein the image associated with the one or more virtual resources includes a directional indicator toward the location of the incident at the premises.

In some aspects, the techniques described herein relate to a method, further including displaying a map of the premises including an indication of the current location of the mobile device.

In some aspects, the techniques described herein relate to a method, wherein the one or more virtual resources include a current location of one or more other responders for the incident.

In some aspects, the techniques described herein relate to a method, wherein the camera feed includes video metadata including output from one or more sensors of the mobile device.

In some aspects, the techniques described herein relate to a method, wherein the one or more virtual resources includes a video feed or data stream from the network video recorder.

In some aspects, the techniques described herein relate to a method, wherein the camera feed includes metadata associated with a video recorded by the mobile device.

In some aspects, the techniques described herein relate to a system for providing guidance regarding an incident at a premises to a responder, the system including: a network video recorder (NVR) system deployed at the premises, the NVR system including a plurality of cameras; a video management system (VMS) including one or more memories storing computer-executable instructions and one or more processors, individually or in combination, configured to execute the instructions to: receive video feeds from the NVR; detect an incident at the premises; send a notification including a location of the incident at the premises to a mobile device of the responder; send one or more virtual resources associated with locations within the premises based on a current location of the mobile device; and receive a camera feed from the mobile device.

In some aspects, the techniques described herein relate to a system, wherein the one or more virtual resources include an access control for a hardware component of the NVR, wherein the VMS is configured to transmit a command to control the hardware component via the NVR in response to an interaction of the responder with the access control on the mobile device.

In some aspects, the techniques described herein relate to a system, wherein the one or more virtual resources include a current location of one or more other responders for the incident.

In some aspects, the techniques described herein relate to a system, wherein the camera feed includes video metadata including output from one or more sensors of the mobile device.

In some aspects, the techniques described herein relate to a system, wherein the one or more virtual resources includes a video feed or data stream from the NVR.

In some aspects, the techniques described herein relate to a system, wherein the camera feed includes metadata associated with a video recorded by the mobile device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a schematic diagram of a video management system and mobile device, according to some aspects;

FIG. 2 is a block diagram of an example computing device which may implement all or a portion of any component or device in FIG. 1, according to some aspects;

FIG. 3 is a message diagram illustrating example communications between the video management system and the user device;

FIG. 4 is an example user interface of the user device.

FIG. 5 is a flowchart of an example method of a mobile device for providing guidance regarding an incident at a premises to a responder.

FIG. 6 is a flowchart of an example method of a video management system for providing guidance regarding an incident at a premises to a responder.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components may be shown in block diagram form in order to avoid obscuring such concepts.

A premises may include a network video recorder (NVR) configured to provide one or more video feeds to a video management system (VMS). For example, the NVR may be a security system for the premises, and the VMS may provide monitoring and control of the premises. The VMS may detect an incident at the premises. For example, the NVR may record a suspicious person in an area that should not be accessed. As another example, the NVR may be associated with other sensors such as window sensors, door sensors, etc. that may indicate an incident.

In some cases, a responder may be deployed to the premises in response to an incident. In an aspect, the present disclosure provides a mobile device that facilitates deployment of a responder to an incident. The mobile device provides information from the VMS to the responder. The mobile device adds a camera feed to the NVR to provide additional information to the VMS. In an aspect, the mobile device receives virtual resources from the VMS. For example, the virtual resources may correspond to other responders or hardware components associated with the VMS (e.g., cameras, doors, control panels, sensors, etc.). The mobile device may augment the camera feed with the virtual resources for display to the responder. Accordingly, the responder may receive enhanced information for responding to the incident.

Turning now to the figures, example aspects are depicted with reference to one or more components described herein, where components in dashed lines may be optional.

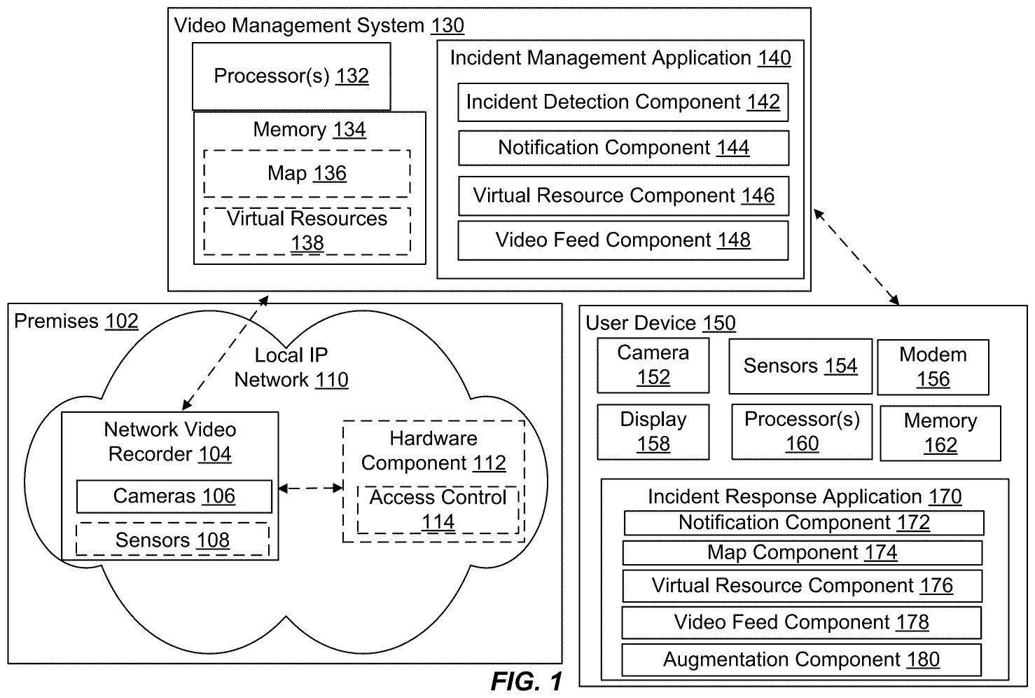

Referring to FIG. 1, in one non-limiting aspect, for example, a premises 102 includes a network video recorder (NVR) 104. The NVR 104 includes a plurality of cameras 106. Each camera is configured to generate a video feed and transmit the video feed to a video management system (VMS) 130 via the NVR 104. For example, the cameras 106 may each be connected to a local IP network 110 and transmit their respective video feeds via the local IP network 110. In some implementations, the NVR 104 includes sensors 108. For example, sensors 108 may include window sensors, door sensors, glass break sensors, smoke detectors, heat detectors, laser sensors, audio sensors, motion sensors, carbon monoxide detectors, flood sensors and any other sensors that may be deployed at a premises. The sensors 108 may, for example, provide a data stream to the NVR 104 and/or transmit alarms when the sensor 108 detects a configured condition. In some implementations, the NVR 104, VMS 130, and/or sensors 108 may be referred to as a building management system (BMS).

In some implementations, the premises 102 may include various hardware components 112. A hardware component 112 may provide input to the NVR 104 or be controlled by the NVR 104. For example, a hardware component 112 may include a door lock. The hardware component 112 may be associated with an access control 114. The NVR 104 may issue commands to the access control 114 to control the hardware component 112 (e.g., unlock a door).

In an aspect, a VMS 130 communicates with the NVR. For example, the VMS 130 receives the video streams transmitted by the NVR 104. The VMS 130 may be implemented as a computer server including one or more processors 132 configured to execute instructions stored on one or more memories 134. In some implementations, the VMS 130 may be implemented on cloud resources distributed over multiple datacenters. In some implementations, the VMS 130 provides a user interface to allow an operator to interact with the VMS 130.

In an aspect, the memory 134 of the VMS 130 stores information regarding a premises 102. For example, the memory 134 may store a map 136. The map 136 may be a three dimensional map that includes locations of objects. For instance, the map 136 may include a floor plan of each level of the premises. The memory 134 may store virtual resources 138. A virtual resource 138 may correspond to an object or device at the premises 102. For example, a virtual resource 138 may correspond to a hardware component 112 and include a virtual access control 114. In other aspects, the virtual resources 138 may include a graphical user interface for interacting with components of the virtual resources 138. The virtual resource 138 may be provided to a user device 150 to provide a responder with a representation of the hardware component 112 and interact with the access control 114.

The VMS 130 includes an incident management application 140. The incident management application 140 communicates with an incident response application 170 on the user device 150 to facilitate actions by a responder. The incident management application 140 may include an incident detection component 142, a notification component 144, a virtual resource component 146, and a video feed component 148. The video feed component 148 is configured to receive video feeds from the NVR 104. The incident detection component 142 is configured to detect an incident at the premises 102. For example, the incident detection component 142 may detect an incident based on the video feeds or an alarm from a sensor 108. In some implementations, an operator may observe the video feeds and/or alarms and initiate an incident via a user interface of the incident detection component 142. The notification component 144 is configured to send a notification including a location of the incident at the premises 102 to a mobile device (e.g., user device 150) of the responder. The virtual resource component 146 is configured to send one or more virtual resources 138 associated with locations within the premises based on a current location of the mobile device. The video feed component 148 is further configured to receive a camera feed from the user device 150. For example, the camera feed from the user device 150 may be processed in a similar manner as a video feed from the NVR 104, thereby expanding the capability of the VMS 130.

The user device 150 may be a mobile device configured to provide a user (e.g., a responder) with information regarding an incident at a premises 102. For example, the user device 150 may be a smartphone, a tablet, a laptop computer, or a virtual or augmented reality headset. The user device 150 may include one or more cameras 152, sensors 154, a modem 156, a display 158, one or more processors 160, and one or more memories 162.

The user device 150 is configured with an incident response application 170 to control communication with the VMS 130 and display information to the responder. The incident response application 170 includes a notification component 172, a map component 174, a virtual resource component 176, a video feed component 178, and an augmentation component 180. The notification component 172 is configured to receive a notification including a location of the incident at the premises 102. The map component 174 is configured to display a map from a current location of the mobile device to the premises. In some implementations, the map component 174 may utilize an external map service that provides street level maps and driving information such as turns and traffic. In some implementations, the map component 174 is configured to transmit, the current location of the mobile device to a central controller of the NVR 104 (e.g., the VMS 130). The virtual resource component 176 is configured to receive, from the central controller, one or more virtual resources 138 at the premises 102 near the location of the mobile device (e.g., user device 150). The video feed component 178 is configured to add a camera feed of the mobile device as a new camera within the NVR 104. For example, the camera feed may include the actual video stream recorded by the camera 152 and/or metadata associated with the video stream (e.g., identified objects or information from sensors 154). The augmentation component 180 is configured to augmenting the camera feed on the mobile device with an image associated with the one or more virtual resources. For example, the image may be a symbol included in or indicated by the virtual resource 138. The augmentation component 180 may determine a location of an object corresponding to the virtual resource 138 in the camera feed based on the location and orientation of the user device 150 and the location of the virtual resource 138. The augmentation component 180 may display the image associated with the virtual resource 138 over the camera feed, for example, to help the responder locate the object corresponding to the virtual resource, provide additional information about the object, or enable control of the object.

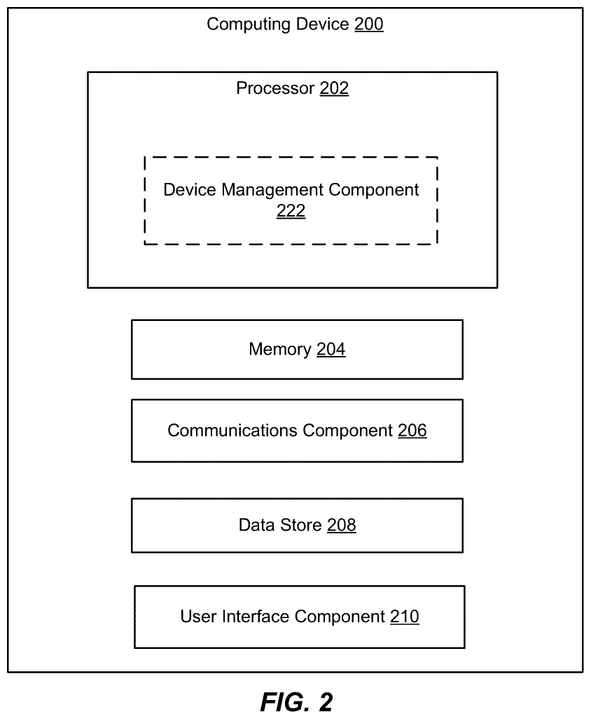

FIG. 2 illustrates an example block diagram providing details of computing components in a computing device 200 that may implement all or a portion of one or more components in a control panel, a cloud system, a security/automation sensor or device, a user device (e.g., a smartphone, a tablet, a laptop computer, a desktop computer, etc.), a dedicated device, or any other component described above. For example, the computing device 200 may implement the NVR 104, the VMS 130, the user device 150, or a hardware component 112. The computing device 200 includes a processor 202 which may be configured to execute or implement software, hardware, and/or firmware modules that perform any functionality described above with reference to one or more components in a control panel, a cloud system, a security/automation sensor or device, a user device, a dedicated device, or any other component described above. For example, the processor 202 may be configured to execute a device management component 222 to provide device management functionality as described herein with reference to various aspects.

The processor 202 may be a micro-controller and/or may include a single or multiple set of processors or multi-core processors. Moreover, the processor 202 may be implemented as an integrated processing system and/or a distributed processing system. The computing device 200 may further include a memory 204, such as for storing local versions of applications being executed by the processor 202, related instructions, parameters, etc. The memory 204 may include a type of memory usable by a computer, such as random access memory (RAM), read only memory (ROM), tapes, flash drives, magnetic discs, optical discs, volatile memory, non-volatile memory (e.g., a non-transitory computer-readable medium storing instructions executable by the processor 202), and any combination thereof. Additionally, the processor 202 and the memory 204 may include and execute an operating system executing on the processor 202, one or more applications, display drivers, etc., and/or other components of the computing device 200.

Further, the computing device 200 may include a communications component 206 that provides for establishing and maintaining communications with one or more other devices, parties, entities, etc., utilizing hardware, software, and services. The communications component 206 may carry communications between components on the computing device 200, as well as between the computing device 200 and external devices, such as devices located across a communications network and/or devices serially or locally connected to the computing device 200. For example, the communications component 206 may include one or more buses, and may further include transmit chain components and receive chain components associated with a wireless or wired transmitter and receiver, respectively, operable for interfacing with external devices.

Additionally, the computing device 200 may include a data store 208, which can be any suitable combination of hardware and/or software, that provides for mass storage of information, databases, and programs. For example, the data store 208 may be or may include a data repository for applications and/or related parameters not currently being executed by the processor 202. In addition, the data store 208 may be a data repository for an operating system, application, display driver, etc., executing on the processor 202, and/or one or more other components of the computing device 200.

The computing device 200 may also include a user interface component 210 operable to receive inputs from a user of the computing device 200 and further operable to generate outputs for presentation to the user (e.g., via a display interface to a display device). The user interface component 210 may include one or more input devices, including but not limited to a keyboard, a number pad, a mouse, a touch-sensitive display, a navigation key, a function key, a microphone, a voice recognition component, or any other mechanism capable of receiving an input from a user, or any combination thereof. Further, the user interface component 210 may include one or more output devices, including but not limited to a display interface, a speaker, a haptic feedback mechanism, a printer, any other mechanism capable of presenting an output to a user, or any combination thereof.

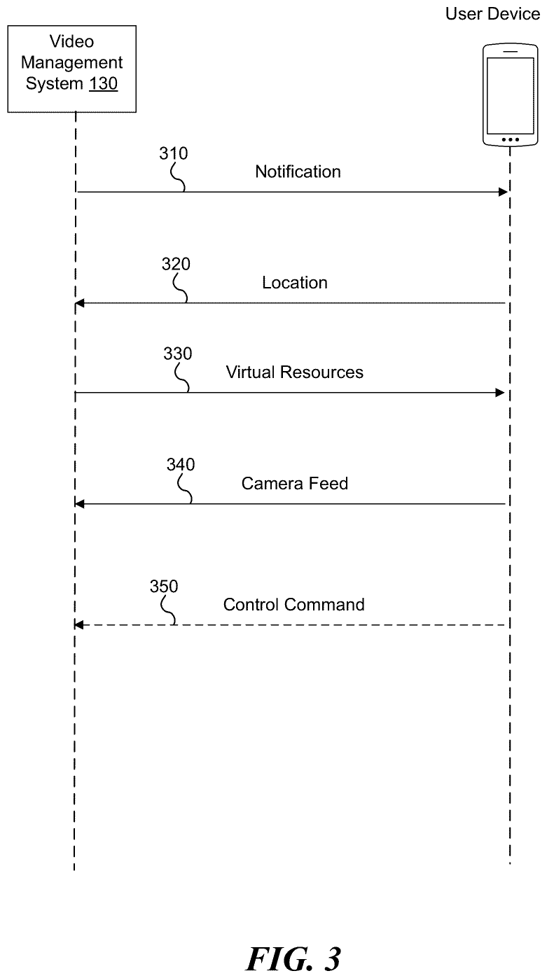

FIG. 3 is a message diagram illustrating example communications between the VMS 130 and the user device 150. The VMS 130 sends a notification 310. The notification 310 includes the location of the incident at the premises 102. The user device 150 sends a location 320 of the user device 150. In some implementations, the user device 150 may determine the location based on a global positioning system (GPS) receiver. The user device 150 may determine a more accurate location (e.g., indoors) based on wireless network signals and a camera feed. The VMS 130 sends virtual resources 330. The virtual resources 330 may include a selection of the virtual resources 138 based on the location of the user device 150. For example, the VMS 130 and/or virtual resource component 146 may select the nearest virtual resources 138 on the same level as the user device 150. In some implementations, the virtual resources 330 may include the map 136 or a portion thereof. For example, the VMS 130 may send a portion of the map corresponding to a floor of the premises 102 where the user device 150 is located. In some implementations, the location of the virtual resources 138 may correspond to a coordinate system of the map 136. The user device 150 transmits a camera feed 340. The camera feed 340 may include one or more images detected by the camera 152 and/or metadata such as information from sensors 154 (e.g., detected movement). In some implementations, either the VMS 130 or the user device 150 may refine a location of the user device 150 based on the camera feed, the map 136, and location of virtual resource 138. In some implementations, the user device 150 may transmit a control command 350. For example, the control command 350 may be associated with a virtual resource 138 (e.g., a virtual control corresponding to the access control 114 of the hardware component 112). The VMS 130 may send a command to the hardware component 112 via the NVR 104 to operate the access control 114. For instance, the responder may interact with the virtual resource 138 to lock or unlock a door corresponding to the virtual resource.

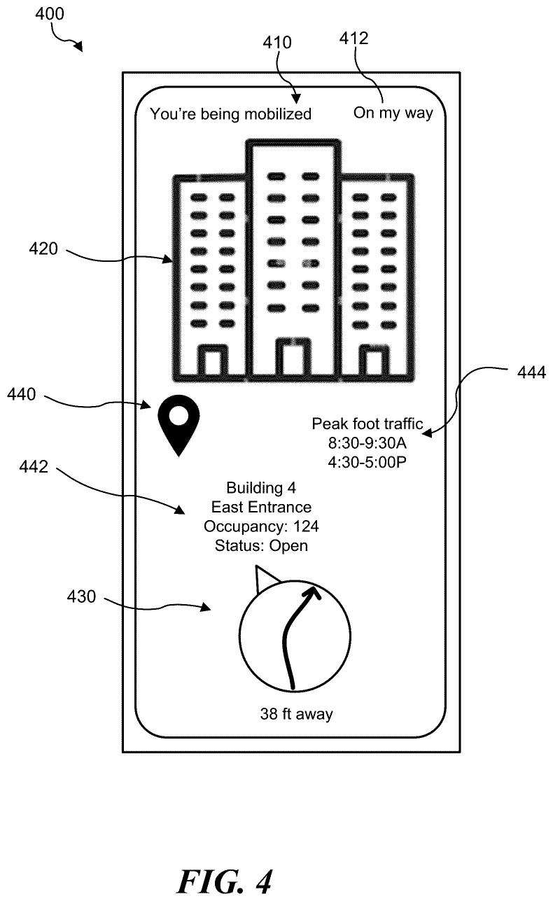

FIG. 4 is an example user interface 400 of the user device 150. For example, the incident response application 170 may display the user interface 400 on the display 158.

The user interface 400 includes a notification 410 corresponding to the notification 310. That is, the incident response application 170 may display the notification 410 in response to receiving the notification 310. The notification 410 may include a response button 412 that allows a responder to accept or decline the notification.

The user interface 400 includes an image 420 from the camera feed of camera 152. For example, the incident response application 170 may directly display the camera feed and display other elements of the user interface 400 over the image 420.

The user interface 400 includes a map display 430. For example, the map display 430 may display a current location of the user device, a map including a path to the location of the incident, and a direction of the incident.

The user interface 400 includes an image 440 corresponding to a virtual resource 138. In the illustrated example, the image 440 is a marker for an entrance. Another image 442 provides information regarding the virtual resource. In some implementations, the illustrated status may provide an interactive access control for the hardware component associated with the virtual resource. The image 444 provides additional information regarding a virtual resource.

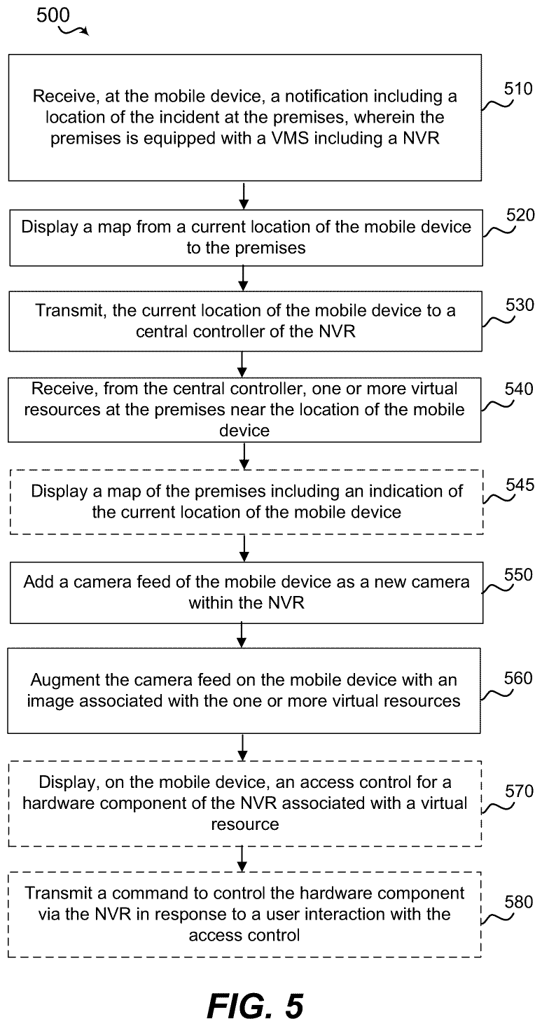

FIG. 5 is a flowchart of an example method 500 for providing guidance regarding an incident at a premises to a responder. The user device 150 may perform the method 500 such as via execution of the incident response application 170 by processor(s) 160 and/or memory 162. For example, the memory 162 may store computer-executable code and the processor(s) 160 may execute the computer-executable code to cause the user device 150 to perform the method 500 when executed by the one or more processor(s) 160, individually or in combination. Further, the user device 150 may be configured to perform the method 500 in communication with the VMS 130, as described herein.

At block 510, the method 500 includes receiving, at the mobile device, a notification including a location of the incident at the premises, wherein the premises is equipped with a VMS including an NVR. For example, in an aspect, user device 150, processor 160, memory 162, and/or incident response application 170 may be configured to or may comprise means for receiving, at the mobile device, a notification 310 including a location of the incident at the premises 102. The premises 102 is equipped with a VMS 130 including an NVR 104. The incident may include events that require attention from one or more responders. Examples of the incident may include a medical emergency, vehicular accident, work-related accident, fire, flood, intrusion, trespassing, theft, etc.

At block 520, the method 500 includes displaying a map from a current location of the mobile device to the premises. For example, in an aspect, user device 150, processor 160, memory 162, and/or incident response application 170 may be configured to or may comprise means for displaying a map (e.g., map display 430) from a current location of the mobile device (e.g., user device 150) to the premises 102. The map may include one or more graphical displays associated with the current location of the mobile device.

At block 530, the method 500 includes transmitting, the current location of the mobile device to a central controller of the NVR. For example, in an aspect, user device 150, processor 160, memory 162, and/or incident response application 170 may be configured to or may comprise means for transmitting, the current location 320 of the mobile device to a central controller of the NVR (e.g., VMS 130).

At block 540, the method 500 includes receiving, from the central controller, one or more virtual resources at the premises near the location of the mobile device. For example, in an aspect, user device 150, processor 160, memory 162, and/or incident response application 170 may be configured to or may comprise means for receiving, from the central controller, one or more virtual resources 330 at the premises near the location of the mobile device. The one or more virtual resources may include instructions, software, maps, images, and/or other information that the responder uses for navigating to and/or accessing the premises.

At block 545, the method 500 may optionally include displaying a map of the premises including an indication of the current location of the mobile device. For example, in an aspect, user device 150, processor 160, memory 162, and/or incident response application 170 may be configured to or may comprise means for displaying a map 136 of the premises 102 including an indication of the current location of the mobile device.

At block 550, the method 500 includes adding a camera feed of the mobile device as a new camera within the NVR. For example, in an aspect, user device 150, processor 160, memory 162, and/or incident response application 170 may be configured to or may comprise means for adding a camera feed of the mobile device as a new camera within the NVR.

At block 560, the method 500 includes augmenting the camera feed on the mobile device with an image associated with the one or more virtual resources. For example, in an aspect, user device 150, processor 160, memory 162, and/or incident response application 170 may be configured to or may comprise means augmenting the camera feed on the mobile device with an image (e.g., images 440, 442, 444) associated with the one or more virtual resources.

At block 570, the method 500 may optionally include displaying, on the mobile device, an access control for a hardware component of the NVR associated with a virtual resource. For example, in an aspect, user device 150, processor 160, memory 162, and/or incident response application 170 may be configured to or may comprise means for displaying, on the mobile device, an access control 114 for a hardware component 112 of the NVR associated with a virtual resource 138.

At block 580, the method 500 may optionally include transmitting a command to control the hardware component via the NVR in response to a user interaction with the access control. For example, in an aspect, user device 150, processor 160, memory 162, and/or incident response application 170 may be configured to or may comprise means for transmitting a command to control the hardware component 112 via the NVR in response to a user interaction with the access control.

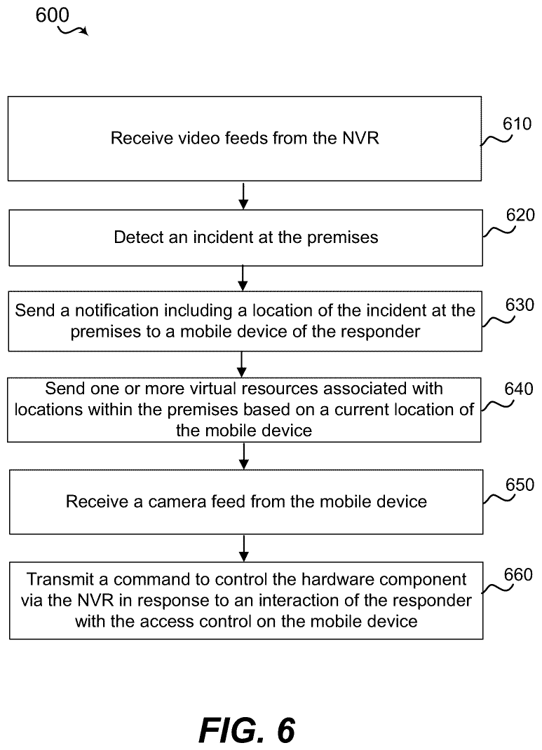

FIG. 6 is a flowchart of an example method 600 for providing guidance regarding an incident at a premises to a responder. The VMS 130 may perform the method 600 such as via execution of the incident management application 140 by processor(s) 132 and/or memory 134. For example, the memory 134 may store computer-executable code and the processor 132 may execute the computer-executable code to cause the VMS 130 to perform the method 600 when executed by the one or more processor(s) 132, individually or in combination. Further, the VMS 130 may be configured to perform the method 600 in communication with the user device 150 and NVR 104, as described herein.

At block 610, the method 600 includes receiving video feeds from the NVR. For example, in an aspect, VMS 130, processor 132, memory 134, and/or incident management application 140 may be configured to or may comprise means for receiving video feeds from the NVR 104.

At block 620, the method 600 includes detecting an incident at the premises. For example, in an aspect, VMS 130, processor 132, memory 134, and/or incident management application 140 may be configured to or may comprise means for detecting an incident at the premises 102.

At block 630, the method 600 includes sending a notification including a location of the incident at the premises to a mobile device of the responder. For example, in an aspect, VMS 130, processor 132, memory 134, and/or incident management application 140 may be configured to or may comprise means for sending a notification 310 including a location of the incident at the premises 102 to a mobile device (e.g., user device 150) of the responder.

At block 640, the method 600 includes sending one or more virtual resources associated with locations within the premises based on a current location of the mobile device. For example, in an aspect, VMS 130, processor 132, memory 134, and/or incident management application 140 may be configured to or may comprise means for sending one or more virtual resources 330 associated with locations within the premises 102 based on a current location of the mobile device.

At block 650, the method 600 includes receiving a camera feed from the mobile device. For example, in an aspect, VMS 130, processor 132, memory 134, and/or incident management application 140 may be configured to or may comprise means for receiving a camera feed from the mobile device.

At block 660, the method 600 may optionally include transmitting a command to control a hardware component via the NVR in response to an interaction of the responder with the access control on the mobile device. For example, in an aspect, VMS 130, processor 132, memory 134, and/or incident management application 140 may be configured to or may comprise means for transmitting a command to control a hardware component 112 via the NVR 104 in response to an interaction of the responder with the access control on the mobile device.

Some further example aspects are provided below.

Clause 1. A method of providing guidance regarding an incident at a premises to a responder, the method executed on a mobile device and comprising: receiving, at the mobile device, a notification including a location of the incident at the premises, wherein the premises is equipped with a video management system (VMS) including a network video recorder (NVR); displaying a map from a current location of the mobile device to the premises; transmitting, the current location of the mobile device to a central controller of the NVR; receiving, from the central controller, one or more virtual resources at the premises near the location of the mobile device; adding a camera feed of the mobile device as a new camera within the NVR; and augmenting the camera feed on the mobile device with an image associated with the one or more virtual resources.

Clause 2. The method of clause 1, further comprising: displaying, on the mobile device, an access control for a hardware component of the NVR associated with a virtual resource; and transmitting a command to control the hardware component via the NVR in response to a user interaction with the access control.

Clause 3. The method of clause 1 or 2, wherein the image associated with the one or more virtual resources includes a directional indicator toward the location of the incident at the premises.

Clause 4. The method of any of clauses 1-3, further comprising displaying a map of the premises including an indication of the current location of the mobile device.

Clause 5. The method of any of clauses 1-4, wherein the one or more virtual resources include a current location of one or more other responders for the incident.

Clause 6. The method of any of clauses 1-5, wherein the camera feed includes video metadata including output from one or more sensors of the mobile device.

Clause 7. The method of any of clauses 1-6, wherein the one or more virtual resources include a video feed or data stream from the NVR.

Clause 8. The method of any of clauses 1-7, wherein the camera feed includes metadata associated with a video recorded by the mobile device.

Clause 9. A system for providing guidance regarding an incident at a premises to a responder, the system comprising: a network video recorder (NVR) system deployed at the premises, the NVR system including a plurality of cameras; a video management system (VMS) including one or more memories storing computer-executable instructions and one or more processors, individually or in combination, configured to execute the instructions to: receive video feeds from the NVR; detect an incident at the premises; send a notification including a location of the incident at the premises to a mobile device of the responder; send one or more virtual resources associated with locations within the premises based on a current location of the mobile device; and receive a camera feed from the mobile device.

Clause 10. The system of clause 9, wherein the one or more virtual resources include an access control for a hardware component of the NVR, wherein the VMS is configured to transmit a command to control the hardware component via the NVR in response to an interaction of the responder with the access control on the mobile device.

Clause 11. The system of clause 9 or 10, wherein the VMS is configured to transmit a three-dimensional map of the premises to the mobile device.

Clause 12. The system of any of clauses 9-11, wherein the one or more virtual resources include a current location of one or more other responders for the incident.

Clause 13. The system of any of clauses 9-12, wherein the camera feed includes video metadata including output from one or more sensors of the mobile device.

Clause 14. The system of any of clauses 9-13, wherein the one or more virtual resources includes a video feed or data stream from the NVR.

Clause 15. The system of any of clauses 9-14, wherein the camera feed includes metadata associated with a video recorded by the mobile device.

Clause 16. An apparatus for providing guidance regarding an incident at a premises to a responder, comprising: one or more memories storing computer-executable instructions; and one or more processors, individually or in combination, configured to execute the computer-executable instructions to cause the apparatus to: receive a notification including a location of the incident at the premises, wherein the premises is equipped with a video management system (VMS) including a network video recorder (NVR); display a map from a current location of the apparatus to the premises; transmit, the current location of the mobile device to a central controller of the NVR; receive, from the central controller, one or more virtual resources at the premises near the location of the mobile device; add a camera feed of the mobile device as a new camera within the NVR; and augment the camera feed on the mobile device with an image associated with the one or more virtual resources.

Clause 17. The apparatus of clause 16, wherein the one or more processors, individually or in combination, are configured to perform the method of any of clauses 1-8.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of providing guidance regarding an incident at a premises to a responder, the method executed on a mobile device and comprising:
receiving, at the mobile device, a notification including a location of the incident at the premises, wherein the premises is equipped with a video management system (VMS) including a network video recorder (NVR);
displaying a map from a current location of the mobile device to the premises;
transmitting, the current location of the mobile device to the VMS;
receiving, from the VMS, one or more virtual resources at the premises near the location of the mobile device;
adding a camera feed of the mobile device as a new camera within the NVR; and
augmenting the camera feed on the mobile device with an image associated with the one or more virtual resources.

2. The method of claim 1, further comprising:
displaying, on the mobile device, an access control for a hardware component of the NVR associated with a virtual resource; and
transmitting a command to control the hardware component via the NVR in response to a user interaction with the access control.

3. The method of claim 1, wherein the image associated with the one or more virtual resources includes a directional indicator toward the location of the incident at the premises.

4. The method of claim 1, further comprising displaying a map of the premises including an indication of the current location of the mobile device.

5. The method of claim 1, wherein the one or more virtual resources include a current location of one or more other responders for the incident.

6. The method of claim 1, wherein the camera feed includes video metadata including output from one or more sensors of the mobile device.

7. The method of claim 1, wherein the one or more virtual resources includes a video feed or data stream from the NVR.

8. The method of claim 1, wherein the camera feed includes metadata associated with a video recorded by the mobile device.

9. A system for providing guidance regarding an incident at a premises to a responder, the system comprising:
a network video recorder (NVR) system deployed at the premises, the NVR system including a plurality of cameras; and
a video management system (VMS) including one or more memories storing computer-executable instructions and one or more processors, individually or in combination, configured to execute the instructions to:
receive video feeds from the NVR;
detect an incident at the premises;
send a notification including a location of the incident at the premises to a mobile device of the responder;
send one or more virtual resources associated with locations within the premises based on a current location of the mobile device; and
receive a camera feed from the mobile device.

10. The system of claim 9, wherein the one or more virtual resources include an access control for a hardware component of the NVR, wherein the VMS is configured to transmit a command to control the hardware component via the NVR in response to an interaction of the responder with the access control on the mobile device.

11. The system of claim 9, wherein the VMS is configured to transmit a three-dimensional map of the premises to the mobile device.

12. The system of claim 9, wherein the one or more virtual resources include a current location of one or more other responders for the incident.

13. The system of claim 9, wherein the camera feed includes video metadata including output from one or more sensors of the mobile device.

14. The system of claim 9, wherein the one or more virtual resources includes a video feed or data stream from the NVR.

15. The system of claim 9, wherein the camera feed includes metadata associated with a video recorded by the mobile device.

16. An apparatus for providing guidance regarding an incident at a premises to a responder, comprising:
one or more memories storing computer-executable instructions; and
one or more processors, individually or in combination, configured to execute the computer-executable instructions to cause the apparatus to:
receive a notification including a location of the incident at the premises, wherein the premises is equipped with a video management system (VMS) including a network video recorder (NVR);
display a map from a current location of the apparatus to the premises;
transmit, the current location of the apparatus to the VMS;
receive, from the VMS, one or more virtual resources at the premises near the location of the apparatus;
add a camera feed of the apparatus as a new camera within the NVR; and
augment the camera feed on the apparatus with an image associated with the one or more virtual resources.
